(19) United States
(12) Patent Application Publication
(10) Pub. No.: US 2021/0038346 A1
(43) Pub. Date: Feb. 11, 2021

(54) METAL ORTHODONTIC RETAINER OR DENTAL FLIPPER

(71) Applicant: Dean UltraThin Retainer, LLC, Fosston, MN (US)

(72) Inventors: Todd Sandwick, Fosston, MN (US); Bryce Oakes, Fosston, MN (US)

(21) Appl. No.: 16/964,102

(22) PCT Filed: Jan. 25, 2019
(86) PCT No.: PCT/US2019/015146

§ 371 Date: Jul. 22, 2020

Related U.S. Application Data
(60) Provisional application No. 62/626,403, filed on Feb. 5, 2018.

(51) Int. Cl. A61C 7/08; A61C 7/00; A61C 13/00

(52) U.S. Cl. CPC A61C 7/08; A61C 13/0019; A61C 7/002

(57) ABSTRACT

A dental appliance, such as an orthodontic retainer or a dental flipper, made of metal, graphene, carbon, or carbon fiber, and techniques for forming the dental appliance are described. In the case of an orthodontic retainer, the retainer can be used to retain the upper set of teeth or the lower set of teeth. The dental appliance can be formed by an additive manufacturing process such as 3D printing.

### FIELD

This disclosure relates to a dental appliance, such as an orthodontic retainer, made of metal, where the retainer is thinner, stronger, more hygienic, encourages greater patient compliance, and has less effects on negative speech patterns compared to traditional non-metal orthodontic retainers.

### BACKGROUND

Orthodontic retainers have been in use for years in the orthodontic field for providing orthodontic retention after completion of an active phase of orthodontic treatment. One commonly utilized orthodontic retainer is referred to as a Hawley-type retainer, which is generally comprised of a palatal portion, often formed from plastic or acrylic material, and a labial wire attached at both ends to the palatal portion. The palatal portion is generally positioned against the palate of a patient and the labial wire generally extends around the anterior surface of the frontal teeth of the patient.

The use of plastic or acrylic materials for the palatal portion of orthodontic retainers generally suffers from a number of shortcomings. The palatal portion is generally bulky since the acrylic and plastic materials utilized for such palatal portions will generally require a minimum thickness of 1.5 millimeters or more to provide the requisite structural strength. A palatal portion of this thickness results in discomfort for a patient who must wear such a retainer for hours each day. These thick palatal portions also tend to negatively impact speech patterns of the patient when the retainer is worn. Further, the acrylic or plastic material utilized for the palatal portion often breaks easily, requiring costly repairs or replacement of the orthodontic retainer, and the acrylic or plastic material tends to retain odors and bacteria.

U.S. Pat. No. 8,827,696 discloses an orthodontic retainer where the palatal portion is made from a metal material to eliminate many of the problems associated with plastic or acrylic palatal portions.

### SUMMARY

An orthodontic retainer made of metal and other materials including, but not limited to, graphene, carbon and carbon fiber, and techniques for forming the orthodontic retainer are described. The orthodontic retainers described herein can be configured for use to retain the upper set of teeth or the lower set of teeth. Other dental appliances that have a construction somewhat similar to the orthodontic retainers are also described.

With respect to the upper set of teeth, the orthodontic retainer can be described as having a lingual portion that is shaped to engage a lingual (or interior) surface of the upper gums of a patient to help retain the upper teeth. The lingual portion may also be shaped to engage a portion of the palate of the patient in addition to the lingual surface of the upper gums. The lingual portion may alternatively be referred to as a palatal portion regardless of whether the lingual portion contacts only the lingual surface of the upper gums or also contacts a portion of the patient's palate.

With respect to the lower set of teeth, the orthodontic retainer can be described as having a lingual portion that is shaped to engage a lingual (or interior) surface of the lower gums of a patient to help retain the lower teeth. The lingual portion may also be shaped to engage a portion of the floor of the mouth of the patient in addition to the lingual surface of the lower gums.

The lingual portions described herein can be made of any materials that provide the requisite durability and strength for the retainer at the minimal thicknesses described herein. In one embodiment, the lingual portion can be made of metal whereby the lingual portion is thinner, stronger, more hygienic, encourages greater patient compliance, and has less effects on negative speech patterns compared to plastic or acrylic palatal portions of traditional orthodontic retainers. In other embodiments, the lingual portion can be made of graphene, carbon, carbon fiber, and other non-metallic materials.

In the case of metal, the metal used to form the lingual portions of the orthodontic retainers described herein can be any metal suitable for use in dental applications and that provides the requisite durability and strength described herein. Examples of metals that can be used include, but are not limited to, gold, platinum, titanium, and metal alloys such as an alloy primarily composed of cobalt, chromium and molybdenum having the brand name VITALLIUM.

In one example, the lingual portion of the orthodontic retainers described herein can be created using an additive manufacturing process. Additive manufacturing as used herein is intended to encompass any process where the lingual portion is created by adding layer-upon-layer of material to create the lingual portion. Additive manufacturing may also be referred to as 3D printing. In another embodiment, the lingual portion of the orthodontic retainers described herein can be created using a subtractive manufacturing process.

However, in some embodiments, the lingual portion of the orthodontic retainers described herein can be created using other manufacturing techniques as well. For example, a casting process as described in U.S. Pat. No. 8,827,696 can be used in some embodiments. U.S. Pat. No. 8,827,696 is incorporated herein by reference in its entirety.

### DRAWINGS

FIG. 1A illustrates an example of an orthodontic retainer described herein configured for use with an upper set of teeth of a patient.

FIG. 1B illustrates an example of an orthodontic retainer described herein configured for use with a lower set of teeth of a patient.

FIG. 2 illustrates the lingual portion of the orthodontic retainer of FIG. 1A without the labial wire.

FIG. 3 illustrates one embodiment of temporary rigid support structures for the lingual portion formed during an additive manufacturing process of the lingual portion.

FIG. 4 illustrates another embodiment of temporary rigid support structures formed during an additive manufacturing process of the lingual portion.

FIG. 5 illustrates another embodiment of temporary rigid support structures formed during an additive manufacturing process of the lingual portion.

FIG. 6 illustrates a lingual portion described herein formed with divots prior to attachment of the labial wire.

FIG. 7 illustrates the lingual portion of FIG. 6 with the ends of the labial wire secured within the divots.

FIG. 8 illustrates an example of a dental flipper formed by the lingual portion and an artificial tooth.

FIG. 9 illustrates another example of a dental flipper.

FIG. 10 illustrates still another example of a dental flipper.

### DETAILED DESCRIPTION

The following is a description of orthodontic retainers and other dental appliances, such as a dental flipper, made of metal or non-metallic materials such as graphene, carbon, carbon fiber, and techniques for forming the orthodontic retainers and dental appliances. The orthodontic retainers described herein can be used to retain an upper set of teeth or a lower set of teeth.

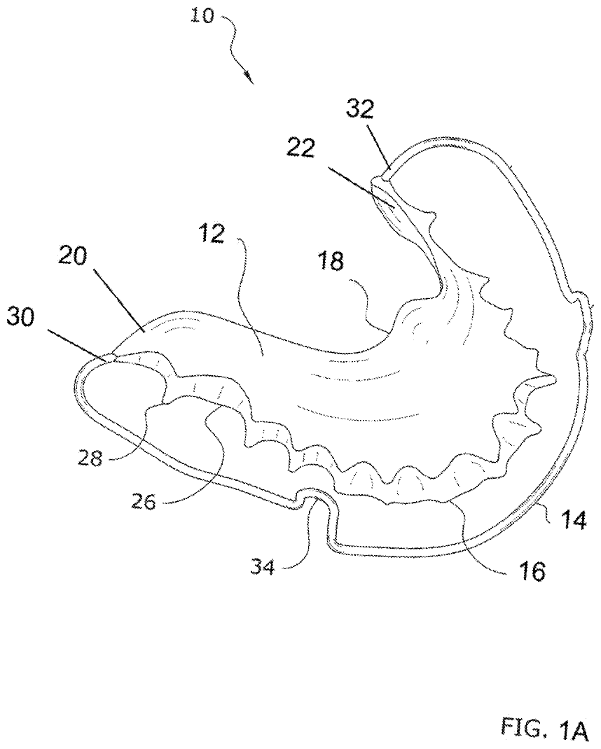

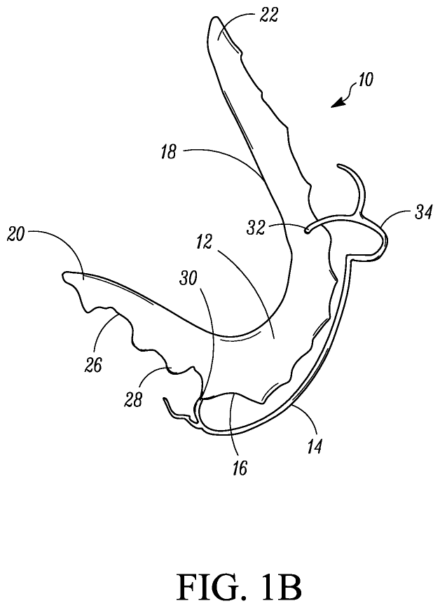

With respect to the upper set of teeth, and referring to FIG. 1A, the orthodontic retainer can be described as having a lingual portion that is shaped to engage a lingual (or interior) surface of the upper gums of a patient to help retain the upper teeth. The lingual portion may also be shaped to engage a portion of the palate of the patient in addition to the lingual surface of the upper gums. The lingual portion may alternatively be referred to as a palatal portion regardless of whether the lingual portion contacts only the lingual surface of the upper gums or also contacts a portion of the patient's palate.

With respect to the lower set of teeth, and referring to FIG. 1B, the orthodontic retainer can be described as having a lingual portion that is shaped to engage a lingual (or interior) surface of the lower gums of a patient to help retain the lower teeth. The lingual portion may also be shaped to engage a portion of the floor of the mouth of the patient in addition to the lingual surface of the lower gums.

For sake of convenience in describing the concepts of the various embodiments disclosed herein, the description and drawings will hereinafter be limited to the orthodontic retainer being configured for use with the upper set of the teeth of a patient as illustrated in FIG. 1A. However, the concepts described herein are applicable to the orthodontic retainer being configured for use with the lower set of the teeth as illustrated in FIG. 1B. In addition, unless otherwise indicated in the claims to the contrary, the claims are to be construed as encompassing both an orthodontic retainer for the upper set of teeth and an orthodontic retainer for the lower set of teeth. Further, many of the features and techniques described herein are applicable to other dental appliances some of which are described further below.

Example Orthodontic Retainer

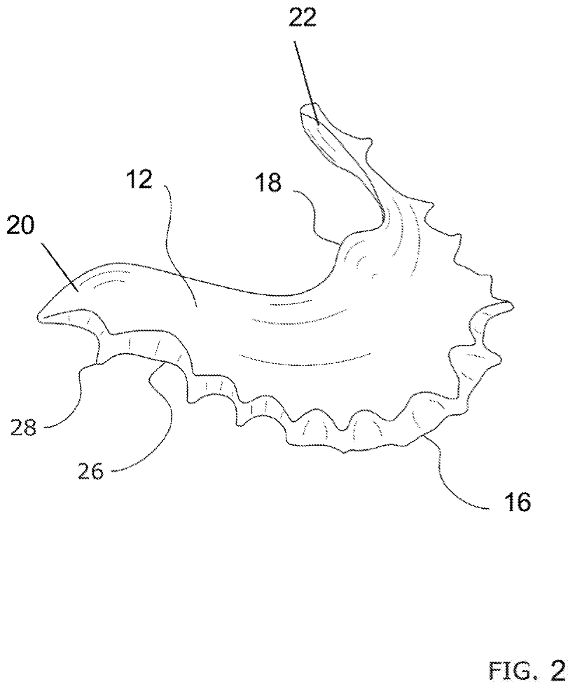

Referring to FIGS. 1A and 2, an example configuration of an orthodontic retainer 10 is illustrated that is configured for use with an upper set of teeth (not illustrated). The orthodontic retainer 10 (or just retainer 10) includes a lingual portion 12 and a labial wire 14. Referring to FIG. 1B, an orthodontic retainer 10 that is configured for use with a lower set of teeth has a construction that is generally similar to the retainer 10 in FIG. 1A.

The lingual portion 12 is formed from any material that provides the requisite durability and strength for the lingual portion 12 at the minimal thicknesses described below. In one embodiment, the material can be metal. The metal can be any metal suitable for use in dental applications and that provides the requisite durability and strength described herein. Examples of metals that can be used include, but are not limited to, gold, platinum, titanium, and metal alloys such as an alloy primarily composed of cobalt, chromium and molybdenum having the brand name VITALLIUM. In another embodiment, the material can be a non-metallic material including, but not limited to, graphene, carbon, and carbon fiber.

The lingual portion 12 is configured to be positioned against a portion of the lingual surfaces of the upper gums and in some embodiments can also be configured to be positioned against a portion of the palate of the patient's mouth when the retainer 10 is worn. The lingual portion 12 is custom fit to the anatomy of a particular patient based on a digital scan or impression of the patient's mouth. The lingual portion 12 is configured as a substantially plate-like member that includes a front edge 16, a rear edge 18, a first end 20 and a second end 22 opposite the first end 20, with the first and second ends 20, 22 interconnecting the front edge 16 and the rear edge 18. In the example illustrated in FIGS. 1A, 1B and 2, the lingual portion 12 has a general shape that can be referred to as U-shaped or horse-shoe shaped. However, the lingual portion 12 can have other shapes as well. In the example illustrated in FIGS. 1A, 1B and 2, the lingual portion 12 is also shown as being solid or continuous without any openings or holes extending through the lingual portion 12. However, in some embodiments, the lingual portion 12 can have one or more openings formed therethrough.

The front edge 16 of the lingual portion 12 is configured to be positionable adjacent to the lingual or rear surfaces of a patient's anterior teeth. In some embodiments, the lingual portion 12 may also generally extend rearwardly along the lingual surfaces of at least a portion of the patient's posterior teeth. The rear edge 18 of the lingual portion 12 may be curved as shown in FIGS. 1 and 2 or, in some embodiments, may be comprised of a straight edge.

The front edge 16 of the lingual portion 12 includes a plurality of indentations 26 and projections 28. The indentations 26 are matched to the anatomy of the patient and are sized and shaped to receive the lingual surfaces of the patient's anterior and posterior teeth. As such, the indentations 26 will generally be pre-formed to accommodate the layout of teeth of the patient. The projections 28 will generally extend at least partially between the teeth of the patient and will similarly be pre-formed to accommodate the particular layout of teeth of the patient.

The lingual portion 12 can have a thickness of between about 0.1 millimeters and about 1.0 millimeters. In another embodiment, the lingual portion 12 can have a thickness of between about 0.1 millimeters and about 0.5 millimeters. In another embodiment, the lingual portion 12 can have a thickness of between about 0.1 millimeters and about 0.3 millimeters. In another embodiment, the lingual portion 12 can have a thickness of between about 0.1 millimeters and about 0.2 millimeters. In another embodiment, the lingual portion 12 can have a thickness that is less than about 0.3 millimeters.

The labial wire 14 is configured to extend across the front edge 16 of the lingual portion 12 and is configured to extend across an anterior portion of the patient's teeth when the retainer 10 is worn so as to ensure proper alignment and setting of the teeth after completion of orthodontic work. The labial wire 14 retains the teeth of the patient between the labial wire 14 and the front edge 16 of the lingual portion 12. In FIG. 1A, the labial wire 14 generally extends outwardly from rear points on the front edge 16 of the lingual portion 12 through spaces between molars and cuspids and extends around the cuspids to extend tightly around the anterior portion of the patient's front teeth or incisors. The labial wire 14 may also optionally include at least one arch wire 34 portion extending upwardly as shown in FIGS. 1A and 1B for gripping by the patient. The labial wire 14 can be made of any material that is suitable for achieving the functions of the labial wire 14 in an orthodontic retainer. For example, the labial wire 14 can be made of metal such as gold, platinum, or a metal alloy such as an alloy primarily composed of cobalt, chromium and molybdenum having the brand name VITALLIUM, or made of a non-metallic material.

Referring to FIG. 1A, the labial wire 14 has a first end 30 that is secured to the end 20 of the lingual portion 12, and a second end 32 which is secured to the end 22 of the lingual portion 12. In FIG. 1B, the ends 30, 32 of the labial wire 14 are not secured to the ends 20, 22 of the lingual portion 12 but are instead secured to intermediate portions of the lingual portion. In some embodiments, for example where the lingual portion 12 is formed by additive manufacturing, the labial wire 14 can be integrally formed with the lingual portion 12 whereby the lingual portion 12 and the labial wire 14 form a single, unitary, one-piece, integrally formed construction.

In another embodiment, the labial wire 14 is initially separate from the lingual portion 12 and must be secured to the lingual portion using a suitable form of securement. The ends 30, 32 can be secured to the ends 20, 22 of the lingual portion 12 in any suitable manner to fixedly secure the labial wire 14 to the lingual portion 12. For example, when the lingual portion 12 is made of metal, the ends 30, 32 can be soldered or welded to the metal of the lingual portion 12.

Further information on the general construction of the retainer 10 can be found in U.S. Pat. No. 8,827,696, which is incorporated herein by reference in its entirety.

Additive Manufacturing

In one embodiment, the lingual portion 12 of the orthodontic retainer 10 can be created using an additive manufacturing process for example using metal or other material suitable for use in an additive manufacturing process. Additive manufacturing as used herein is intended to encompass any process where the lingual portion 12 is created by adding layer-upon-layer of material to create the lingual portion 12. Additive manufacturing may also be referred to as 3D printing. Examples of additive manufacturing techniques that can be utilized include, but are not limited to, Selective Laser Melting (SLM), Selective Laser Sintering (SLS), Direct Metal Laser Sintering/Melting (DMLS or DMLM), Fused Deposition Modeling (FDM), Fused Filament Fabrication (FFF), Stereolithography (SLA), binder jetting, and Laminated Object Manufacturing (LOM). Alternatively, in some embodiments, the lingual portion 12 can be created using a subtractive manufacturing process.

To create the lingual portion 12, a digital scan of relevant portions of the patient's mouth, such as the lingual surfaces of the upper set of teeth, the lingual surfaces of the upper gums and any portion of the palate to be engaged by the lingual portion 12, is obtained to create a digital data file. The digital scan can be performed using conventional digital scanning techniques such as performing a scan of an impression of the patient's mouth, or using an intra-oral digital scanner to intraorally scan the patient's mouth. Examples of intra-oral scanners include, but are not limited to, Planmeca's PlanScan, 3Shape's TRIOS, Sirona's Apollo DI and OmniScan, Invisalign's Itero and 3M's True Definition Scanner. The digital data file can then be transmitted to the location of a suitable additive manufacturing machine, such as a 3D printer, and the data can be formatted for use in the additive manufacturing process. The lingual portion 12 can then be additively manufactured using the data from the digital data file. Applicant believes that processing and formatting digital data for use in creating 3D printed products is well known in the art. Further, the digital data file can easily be saved for later re-fabrication of another lingual portion 12 if necessary.

In this process, the retainer 10, including the lingual portion 12 and the labial wire 14, can be formed without creating or using a physical model of the patient's teeth, and reduces the number of chair visits by the patient. In contrast, the casting process described in U.S. Pat. No. 8,827,696 requires formation of a physical model of the patient's teeth which increases costs and manufacturing time, and requires an additional chair visit by the patient to their caregiver. However, a physical model can be used to form the lingual portion 12 if desired.

Once the lingual portion 12 is formed, the lingual portion 12 can be buffed and polished to make the lingual portion 12 suitable for use in the patient's mouth. In some embodiments, the labial wire 14 can also be additively manufactured together with the lingual portion 12 to form a single, unitary, one-piece, integrally formed construction. Alternatively, if the lingual portion 12 is formed from metal, once the lingual portion 12 is formed, the labial wire 14 can be secured to the lingual portion 12 by soldering or welding the ends 30, 32 of the labial wire 14 to the ends 20, 22 of the lingual portion 12.

During and shortly after the additive manufacturing process of the lingual portion 12, the lingual portion 12 may not have sufficient structural integrity to support itself and maintain the desired shape of the lingual portion 12 until such time as the metal or other material used to form the lingual portion 12 sufficiently solidifies. Therefore, if structural support is deemed necessary, temporary support structure(s) can be additively formed at the same time the lingual portion 12 is additively formed to stabilize the lingual portion 12 until such time that the material used to form the lingual portion 12 sufficiently solidifies. The temporary support structure(s) can then be removed from the lingual portion 12 after manufacturing once the stabilization by the support structures is no longer deemed necessary.

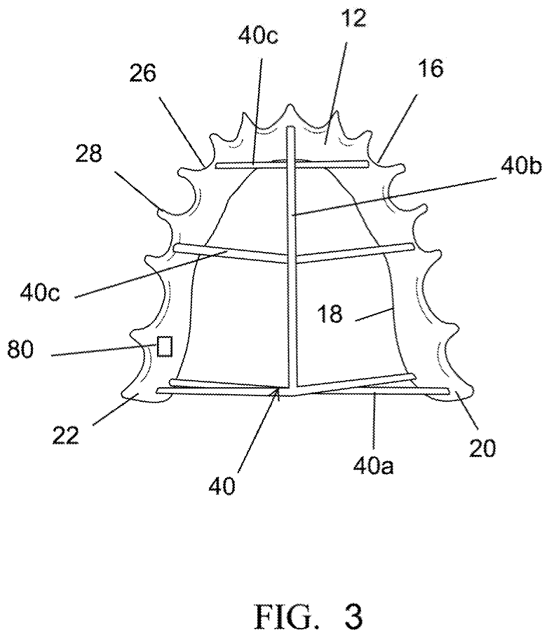

FIGS. 3-5 illustrate different embodiments of temporary support structures. In each of the embodiments in FIGS. 3-5, the temporary support structures are formed by a lattice 40 of rigid metal (or other material) wires that are additively manufactured with the lingual portion 12. The lattice 40 is sufficient to maintain the intended shape of the lingual portion 12 until such time that the material used to form the lingual portion 12 solidifies so that the lingual portion 12 can maintain its own shape.

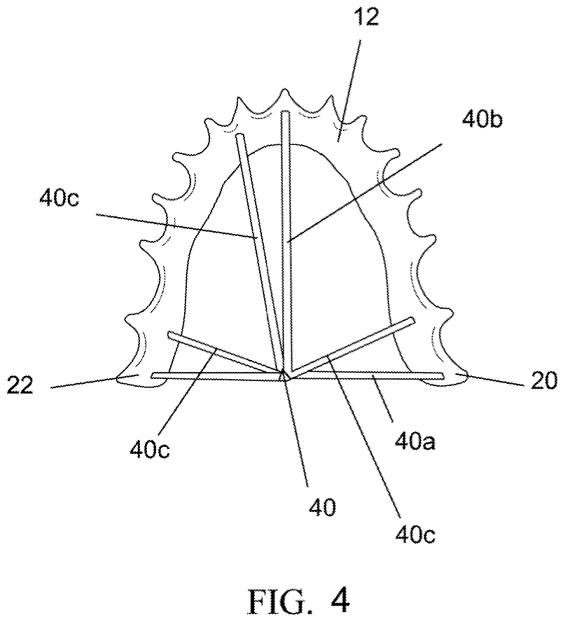

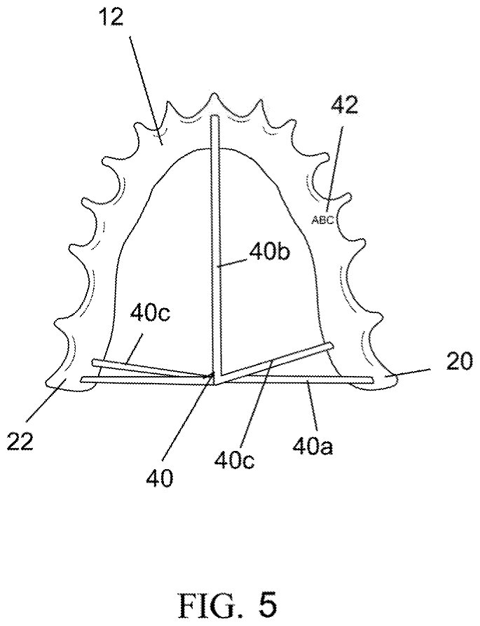

The lattice 40 can have any configuration that is suitable for maintaining the shape of the lingual portion 12. In FIG. 3, the lattice 40 is shown as including a base lateral rigid lattice wire 40a that extends from the end 20 to the end 22, a transverse rigid lattice wire 40b that extends from the lattice wire 40a to the center front of the lingual portion 12, and additional lateral rigid lattice wires 40c that extend from one side of the lingual portion 12 to the other side. In FIG. 4, the lattice 40 is shown as including a base lateral rigid lattice wire 40a that extends from the end 20 to the end 22, a transverse rigid lattice wire 40b that extends from the lattice wire 40a to the center front of the lingual portion 12, and additional angled rigid lattice wires 40c that extend from the lattice wire 40a to various points on the lingual portion 12. In FIG. 5, the lattice 40 is shown as including a base lateral rigid lattice wire 40a that extends from the end 20 to the end 22, a transverse rigid lattice wire 40b that extends from the lattice wire 40a to the center front of the lingual portion 12, and additional angled rigid lattice wires 40c that extend from the lattice wire 40a to various points on the lingual portion 12. The lattice's illustrated in FIGS. 3-5 are examples only. Many other configurations are possible. Any number of rigid lattice wires can be used to form the lattice 40. A single rigid lattice wire could be used in some embodiments. In addition, the temporary support structure is not limited to the use of a lattice formed by rigid lattice wires. Structures that function similarly to the rigid lattice wires can be used, or a plate-like structure could be used.

Once the material of the lingual portion 12 sufficiently solidifies, the rigid lattice wires are removed, for example by cutting them from the lingual portion 12. The locations where the lattice wires connected to the lingual portion 12 can then be buffed and/or polished to make the surfaces at those locations smooth.

Referring to FIG. 5, in one embodiment, graphics 42 such as alphabetical letters, numerals, and/or designs and combinations thereof can be formed in the lingual portion 12. The graphics 42 could be formed during the additive manufacturing process, or the graphics 42 can be added to the lingual portion 12 after the lingual portion 12 is manufactured. For example, a laser can be used to etch the graphics 42 into the material of the lingual portion 12. The graphics 42 can be formed in the non-tissue facing side of the lingual portion 12 as shown in FIG. 5 and/or the graphics 42 can be formed in the tissue facing side (the side opposite to that visible in FIG. 5) of the lingual portion 12.

In some embodiments, when forming the lingual portion 12 by additive manufacturing, the lingual portion 12 may be formed simultaneously together with a plurality of other lingual portions for other patients on a tray. The use of graphics 42 can be useful to help differentiate the lingual portions from one another when the multiple lingual portions are simultaneously manufactured as a batch during additive manufacturing. The graphics 42 can be used to indicate information such as, but not limited to, the patient such as the patient's name or a patient identifier, the patient's doctor, the manufacturing lab, the date of manufacture, and the like. Even if such differentiation is not required, the graphics 42 may be desired by the patient, for example to personalize the retainer 10 and make the retainer unique for the patient, and/or desired by the patient's doctor, for example for marketing.

In addition, the lingual portion 12 is not limited to being formed from a single material such as metal. Instead, the lingual portion 12 can be formed from two or more different metals or other materials. For example, one portion could be formed from a metal alloy while a second portion (such as a portion that may be visible to others when the retainer 10 is worn by the patient) could be formed from gold or platinum. During additive manufacturing, the different metals can be loaded into the additive manufacturing machine as each metal is needed, or the additive manufacturing machine can have multiple printheads, each one associated with a different metal to permit multi-metal formation of the lingual portion 12.

Attaching Labial Wire

As described above, in one embodiment the labial wire 14 may be initially separate from the lingual portion 12 and the ends 30, 32 can be secured to the ends 20, 22 of the lingual portion 12 in any suitable manner, for example by soldering or welding if the lingual portion 12 is metal, to fixedly secure the labial wire 14 to the lingual portion 12. It is desirable that the ends 30, 32 of the wire 14 sit as flush as possible with the surface of the lingual portion 12 to avoid irritation to the patient when the retainer 10 is worn.

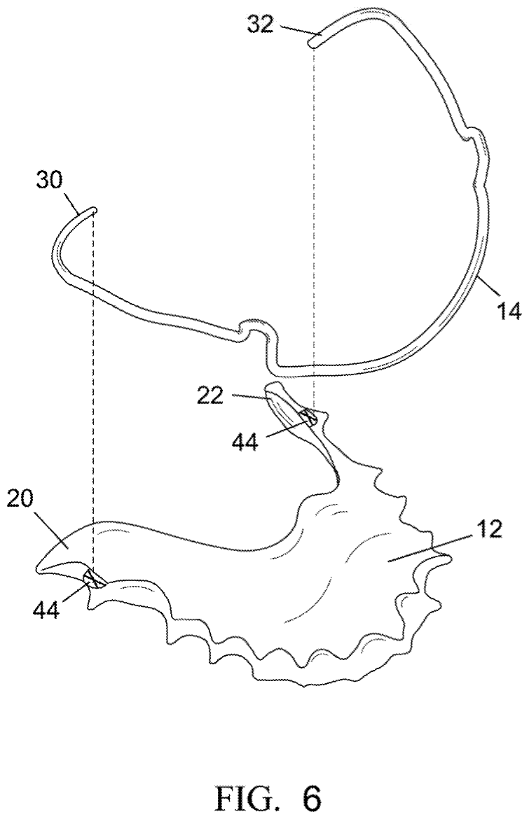

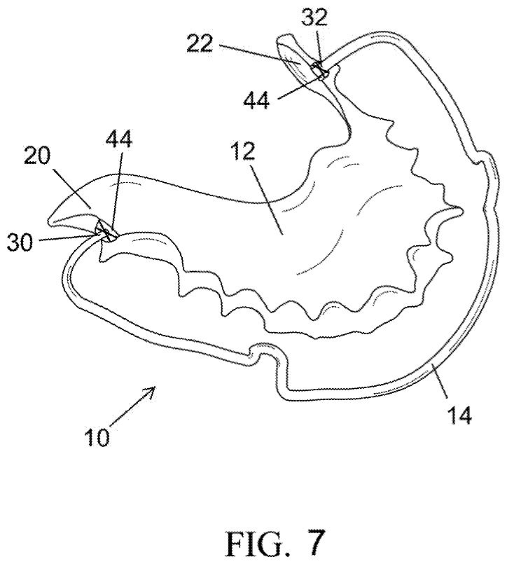

Referring to FIGS. 6 and 7, to help achieve flushness, troughs, divots, recesses, notches or the like 44 (referred to hereinafter as “troughs 44”) can be formed near the ends 20, 22 of the lingual portion 12. The troughs 44 are areas of the lingual portion 12 where a trough is formed in the material of the lingual portion 12. The ends 30, 32 of the labial wire 14 are disposed within the troughs 44, and then the ends 30, 32 are secured in place to the lingual portion 12 using soldering or welding. The troughs 44 can be sized to have a diameter just slight larger than the diameter of the ends 30, 32 of the labial wire 14 so that the ends 30, 32 sit substantially flush within the troughs 44 thereby minimizing the amount of soldering or welding material needed to secure the end 30, 32 to the lingual portion 12 and minimizing the amount of the post-soldering/welding polishing that is required. Alternatively, the ends 30, 32 of the labial wire 14 (or the entire labial wire 14) could be generally flat (instead of cylindrical or round) making it easier for the ends 30, 32 to sit flush with the lingual portion 12.

In the case where the lingual portion 12 is formed by additive manufacturing, the troughs 44 can be created during the additive manufacturing process by not printing metal material at the intended locations of the troughs 44 to form the troughs 44. In another embodiment, the lingual portion 12 can be cast from metal, for example as described in U.S. Pat. No. 8,827,696, and the troughs 44 can be created during the casting process. In still another embodiment, the troughs 44 can be created after the lingual portion 12 is manufactured, whether by additive manufacturing, by casting, or by other process, by forming the troughs 44 therein, for example by machining the lingual portion 12 or by using a laser to ablate the metal to form the troughs 44. Any technique for creating the troughs 44, whether during formation of the lingual portion 12 or after formation of the lingual portion 12, can be utilized.

Dental Flipper

A dental flipper is a removable partial denture or dental appliance that dentists or oral surgeons may use as a replacement if a patient has one or more missing teeth. One or more artificial teeth can be secured to the lingual portion 12 of the retainer 10 described herein, whether formed by additive manufacturing, by casting for example as described in U.S. Pat. No. 8,827,696, or other manufacturing technique, to form a dental flipper. When the lingual portion 12 is worn, the artificial tooth fills in a gap between teeth of the patient wearing the lingual portion 12. The dental flipper may perform a tooth retention function with or without a labial wire attached to the dental flipper, so that the dental flipper also functions as an orthodontic retainer.

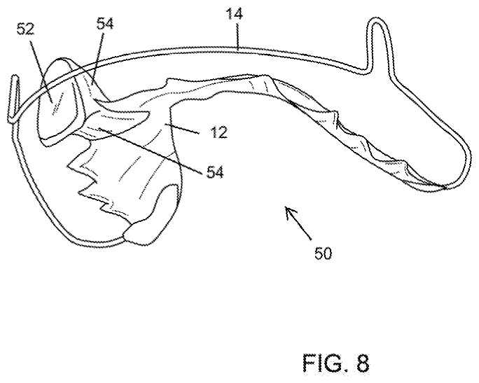

FIG. 8 illustrates an example of a dental flipper 50 that includes the lingual portion 12 and one or more artificial teeth 52 located at the desired position on the lingual portion 12 to fill in for a missing tooth when the patient wears the dental flipper 50. In this embodiment, the tooth 52 can be secured to the metal or other material of the lingual portion 12 in any suitable manner. For example, the tooth 52 can be secured to the lingual portion using an acrylic material 54. The tooth 52 can be a complete tooth or a partial tooth, and any number of complete and/or partial teeth can be secured to the lingual portion 12. In addition, this embodiment shows the flipper 50 as including the labial wire 14.

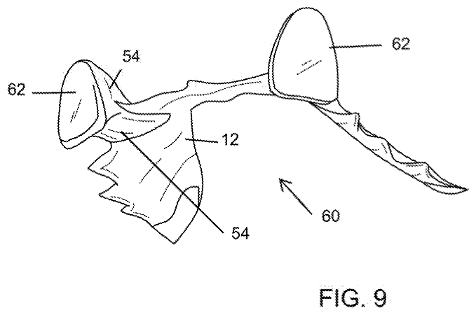

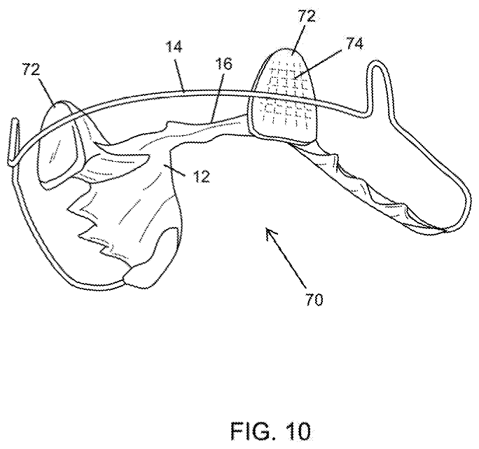

FIG. 9 illustrates another example of a dental flipper 60 that includes the lingual portion 12 and two or more artificial teeth 62 located at the desired positions on the lingual portion 12 to fill in for missing teeth when the patient wears the flipper 60. In this embodiment, the teeth 52 can be secured to the lingual portion 12 in any suitable manner. For example, the teeth 52 can be secured to the lingual portion using an acrylic material 54, using a mesh as described below for FIG. 10, or any other attachment technique. The teeth 52 can be complete teeth and/or partial teeth. In addition, this embodiment shows that the flipper 60 can be used without the labial wire 14.

FIG. 10 illustrates another example of a dental flipper 70 that includes the lingual portion 12 and one or more artificial teeth 72 located at the desired position on the lingual portion 12 to fill in for a missing tooth when the patient wears the flipper 70. In this embodiment, the tooth 72 is illustrated as being secured to the lingual portion 12 using a stiff metal mesh 74. The metal mesh 74 can be created with the lingual portion 12, which can also be metal, during the manufacturing process, for example by additive manufacturing, of the lingual portion 12. The stiff metal mesh 74 hangs down from or near the front edge 16 of the lingual portion 12 and provides a surface around which the tooth 72 can be formed. When forming the tooth 72, the material used to form the tooth 72 can flow around and through the mesh 74, providing secure attachment of the tooth 72 to the lingual portion 12. The mesh 74 is illustrated in broken lines in FIG. 10 for sake of clarity to help explain the concept of the mesh 74. The mesh 74 would not typically be visible to the naked eye since the mesh 74 would typically be completely embedded within the material forming the tooth 72. However, if the tooth 72 were made of transparent or translucent material, then the mesh 74 may be partially or completely visible to the naked eye. The tooth 72 can be a complete tooth and/or a partial tooth. In addition, the flipper 70 can be used with or without the labial wire 14. FIG. 10 shows the flipper 70 with the labial wire 14. However, the flipper 70 need not include the labial wire 14 similar to the embodiment shown in FIG. 9.

Lingual Portion with RFID

Referring to FIG. 3, any of the lingual portions 12 described herein, whether of an orthodontic retainer, a flipper, or other dental appliance, may also be provided with a radio frequency identification (RFID) tag or chip 80. The RFID tag 80 would allow certain data to be stored thereon. For example, the RFID tag 80 can store the patient's name or a patient identifier, the name of the patient's doctor, the manufacturing lab, the date of manufacture, and the like. The RFID tag 80 could be used together with the graphics 42 (FIG. 5), or the RFID tag 80 can be used in place of the graphics 42.

The RFID tag 80 can be secured to the lingual portion 12 in any suitable manner and at any desired location. In one embodiment, a space or recess for the RFID tag 80 can be created or formed in the material of the lingual portion 12, either by the additive manufacturing process or the casting process, or by forming the space or recess post-manufacturing for example by machining or by ablation using a laser. The RFID tag 80 can then be disposed in the space or recess, and acrylic or other suitable material can be used to secure the RFID tag 80 in the space or recess.

The RFID tag 80 can be a passive RFID tag that is powered by electromagnetic energy transmitted from an RFID reader. In this embodiment, the metal of the lingual portion 12 can act as the antenna for the RFID tag 80. In another embodiment, the RFID tag 80 can be an active RFID tag that has its own power source.

The RFID tag 80 can be used with a smartphone application to allow a user to locate the retainer 10 or other dental appliance if lost. If the RFID tag 80 is a passive tag, the smartphone application can cause a smartphone it is loaded on to broadcast a query signal. If the RFID tag 80 is in sufficient proximity to receive the query signal, the query signal can power the RFID tag 80 and cause the RFID tag 80 to transmit a location signal back to the smartphone or cause the RFID tag 80 to emit a sound allowing the user to locate the lost retainer 10 or dental appliance. If the RFID tag 80 is active, the smartphone application can look for a signal that is broadcast by the RFID tag 80.

The following additional embodiments are possible.

Embodiment 1: A method of forming a dental appliance such as an orthodontic retainer or a dental flipper, comprising:
forming a lingual portion of the dental appliance using a metal material, graphene, carbon or carbon fiber, the lingual portion having first and second ends; and
forming troughs in the lingual portion adjacent to the first and second ends.

Embodiment 2: The method of embodiment 1, wherein the troughs are formed in the lingual portion while forming the lingual portion or the troughs are formed in the lingual portion after the lingual portion is formed.

Embodiment 3: A method of forming a dental flipper, comprising:
forming a lingual portion using a metal material, graphene, carbon or carbon fiber; and
securing at least one artificial tooth to the lingual portion.

Embodiment 4: A dental flipper, comprising:
a lingual portion formed entirely of metal, graphene carbon or carbon fiber, the lingual portion including a front edge with a plurality of indentations and projections, and a rear edge;
and at least one artificial tooth secured to the front edge of the lingual portion.

Embodiment 5: A dental appliance such as an orthodontic retainer or a dental flipper, comprising:
a lingual portion formed entirely of metal, graphene, carbon or carbon fiber, the lingual portion including a front edge with a plurality of indentations and projections, and a rear edge;
a labial wire secured to the lingual portion; and
a radio frequency identification tag secured to the lingual portion.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of forming a dental appliance for a patient, comprising:
using a digital data file to control an additive manufacturing machine to form a lingual portion of the dental appliance by additive manufacturing using a metal material, graphene, carbon or carbon fiber; wherein the lingual portion is formed without creating a physical model of the patient's teeth.

2. The method of claim 1, wherein the lingual portion has a thickness of between about 0.1 millimeters and about 0.3 millimeters, or between about 0.1 millimeters and about 0.2 millimeters.

3. The method of claim 1, further comprising using the additive manufacturing machine to form one or more temporary support structures on the lingual portion to temporarily support the lingual portion.

4. The method of claim 1, wherein the lingual portion has first and second ends; and comprising forming troughs in the lingual portion adjacent to the first and second ends.

5. The method of claim 4, wherein the troughs are formed in the lingual portion while forming the lingual portion or the troughs are formed in the lingual portion after the lingual portion is formed.

6. The method of claim 1, further comprising securing a labial wire to the lingual portion.

7. The method of claim 1, further comprising securing at least one artificial tooth to the lingual portion.

8. The method of claim 3, wherein the one or more temporary support structures are formed of the same material as the lingual portion, and removing the one or more temporary support structures from the lingual portion.

9. The method of claim 8, wherein the one or more temporary support structures comprise at least one lattice wire.

10. A dental appliance formed by the method of claim 1.

11. The dental appliance of claim 10, wherein the dental appliance is an orthodontic retainer or a dental flipper.

12. A dental appliance, comprising:
a lingual portion formed entirely of metal, graphene, carbon or carbon fiber using additive manufacturing; the lingual portion including a front edge with a plurality of indentations and projections, and a rear edge.

13. The dental appliance of claim 12, further comprising a labial wire secured to the lingual portion.

14. The dental appliance of claim 12, further comprising at least one artificial tooth secured to the lingual portion.

15. The dental appliance of claim 12, further comprising a radio frequency identification tag secured to the lingual portion.
